(19) United States
(12) Patent Application Publication
(10) Pub. No.: US 2026/0270678 A1
(43) Pub. Date: Sep. 10, 2026

(54) Cellular Service Type for Bootstrap Selection

(71) Applicant: Apple Inc., Cupertino, CA (US)

(72) Inventors: Jean-Marc PADOVA, San Francisco, CA (US); Li LI, Saratoga, CA (US)

(21) Appl. No.: 19/160,906

(22) PCT Filed: Mar. 7, 2024
(86) PCT No.: PCT/US2024/018877

§ 371 Date: Aug. 29, 2025

Related U.S. Application Data
(60) Provisional application No. 63/488,850, filed on Mar. 7, 2023.

(51) Int. Cl. H04W 8/20

(52) U.S. Cl. CPC H04W 8/205

(57) ABSTRACT

An apparatus configured to determine an operation is to be performed, wherein the operation is related to a service type, determine that a current network connection does not support the operation, generate, for transmission to a bootstrap server, a request for a temporary bootstrap profile to perform the operation, wherein the request comprises an indication of the service type, process the temporary bootstrap profile and use the temporary bootstrap profile to perform the operation.

### PRIORITY/INCORPORATION BY REFERENCE

This application claims priority to U.S. Provisional Application Ser. No. 63/488,850 filed on Mar. 7, 2023 and entitled,” the entirety of which is incorporated by reference herein.

### BACKGROUND

A user equipment (UE) may include Universal Integrated Circuit Cards (UICCs) that enable the UE to access services provided by Mobile Network Operators (MNOs), which may also be referred to as carriers. The UICC may be configured to store MNO profiles, also referred to as subscriber identity module (SIM) or SIM profiles that the UE may utilize to register and interact with a carrier to obtain wireless services via a cellular wireless network. In some cases, the UICCs may be embedded directly into the system boards of the UE as embedded UICCs (eUICCs) which can store a number of different MNO profiles also referred to as eSIMs or eSIM profiles for different carriers.

### SUMMARY

Some example embodiments are related to an apparatus having processing circuitry configured to determine an operation is to be performed, wherein the operation is related to a service type, determine that a current network connection does not support the operation, generate, for transmission to a bootstrap server, a request for a temporary bootstrap profile to perform the operation, wherein the request comprises an indication of the service type, process the temporary bootstrap profile and use the temporary bootstrap profile to perform the operation.

Other example embodiments are related to an apparatus having processing circuitry configured to process, based on signals received from a user equipment (UE), a request for a temporary bootstrap profile, wherein the request comprises an indication of a service type, select the temporary bootstrap profile from a pool of temporary bootstrap profiles based on at least the service type, allocate the temporary bootstrap profile to the UE, wherein the temporary bootstrap profile is unavailable for use by other UEs when the temporary bootstrap profile is allocated to the UE and generate, for transmission to the UE, a message comprising the temporary bootstrap profile.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example method for obtaining and using bootstrap IMSI (b-IMSI) according to various example embodiments.

FIG. 4 illustrates an example user operation for initiating emergency call services according to various example embodiments.

FIG. 5 illustrates an example user operation for initiating multiplayer gaming according to various example embodiments.

FIG. 6 shows an example bootstrap server according to various example embodiments.

### DETAILED DESCRIPTION

The example embodiments may be further understood with reference to the following description and the related appended drawings, wherein like elements are provided with the same reference numerals. The example embodiments relate to mechanisms performed at the user equipment (UE) to obtain and utilize bootstrap profiles for specific user operations. As will be described in detail below, some cellular service types may require specific bootstrap profiles that may not be available at the UE.

The example embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a bootstrap server, also referred to as a provisioning server. The UE communicates with the bootstrap server via the cellular wireless network. The bootstrap server may be controlled by any entity, e.g., the cellular provider, the manufacturer of the UE, a third party, etc. In addition, in the example embodiments, the bootstrap server is shown as being a component separate from the cellular network. This is not a requirement; the bootstrap server may be a component of the cellular network. Furthermore, the depiction of a single bootstrap server is also example, the operations described below for the bootstrap server may be performed by more than one bootstrap servers. Finally, the use of the term bootstrap server is example, different entities may refer to the component(s) or function(s) that perform the example operations described below by different names.

A UE may include a bootstrap MNO profile that provides limited functionality connectivity options to allow the UE to connect to a cellular wireless network for certain user operations within the network. Under current circumstances, the bootstrap profile may be uniquely generated and individually assigned to the UE. However, the bootstrap profile may only provide certain types of services, e.g., data services. Thus, in a case where the UE may require a type of service that is not provided by the installed bootstrap profile, e.g., a voice service for an emergency call, the UE will not be able to perform the desired operation.

In the example embodiments, the UE provides information to the bootstrap server indicating the purpose for which the UE may seek temporary access to wireless connectivity. Based on the information, the bootstrap server may perform operations to select a temporary bootstrap International Mobile Subscriber Identity (IMSI) (b-IMSI) value, dedicated for temporary use by the UE. The UE may reconfigure the bootstrap profile on the eUICC with the b-IMSI value obtained from the bootstrap server and establish a new cellular wireless connection using credentials of the bootstrap profile configured with the b-IMSI value to perform the intended actions indicated in the information provided to the bootstrap server. The bootstrap server may limit the use of the b-IMSI value by the UE based on any factor, for example, based on a timer. Thus, after the expiration of the timer or in response to a delete notification message for the b-IMSI value received from the UE, the bootstrap server may return the b-IMSI value to a pool of available b-IMSI values for allocation to other UEs.

The example embodiments introduce mechanisms for the UE to obtain temporary bootstrap profiles to perform specific user operations on the UE. The user operations may relate to, but are not limited to, initiating an emergency call service on the UE, engaging in multiplayer gaming, etc. Although references may be made to the emergency call scenario and multiplayer gaming scenario, these scenarios are only example. The example embodiments may apply to other user operations that may use temporary bootstrap profiles. The example techniques introduced herein may be used independently from one another, in conjunction with other currently implemented mechanisms for obtaining temporary bootstrap profiles, in conjunction with future implementations of mechanisms for obtaining temporary bootstrap profiles or independently from other mechanisms related to obtaining temporary bootstrap profiles.

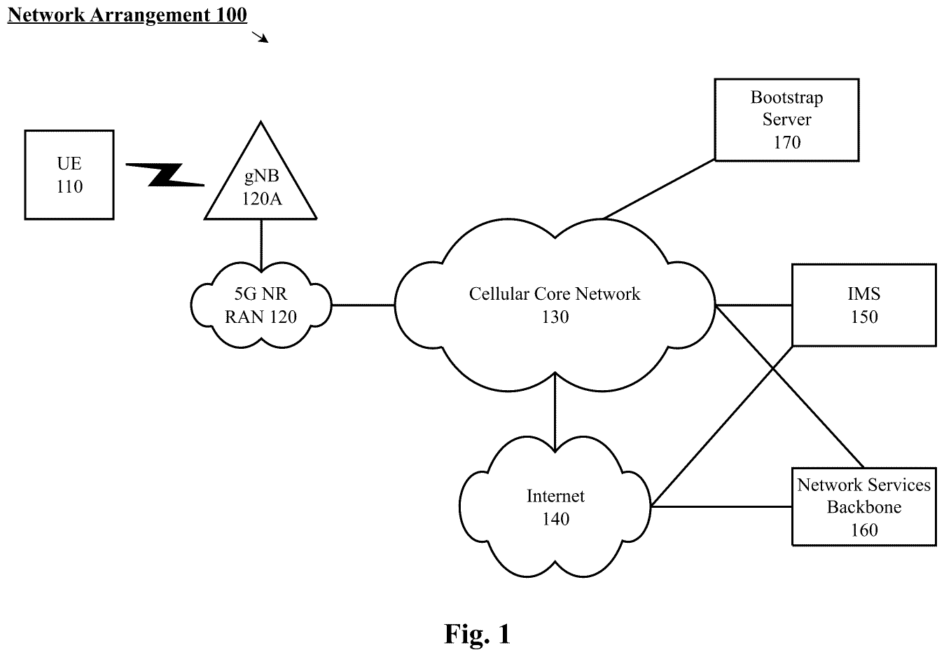

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the example embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, a network services backbone 160 and a bootstrap server 170. The cellular core network 130 may be considered to be the interconnected set of components that manages the operation and traffic of the cellular network. The cellular core network 130 also manages the traffic that flows between the cellular network and the Internet 140. The bootstrap server 170 communicates with UE 110 via the cellular core network 130 to exchange bootstrap data. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

As described above, the bootstrap server 170 may be a component that stores temporary bootstrap profiles and which may allocate one or more of the temporary bootstrap profiles to the UE 110 to perform specific user operations. Example operations performed by the bootstrap server are described in greater detail below.

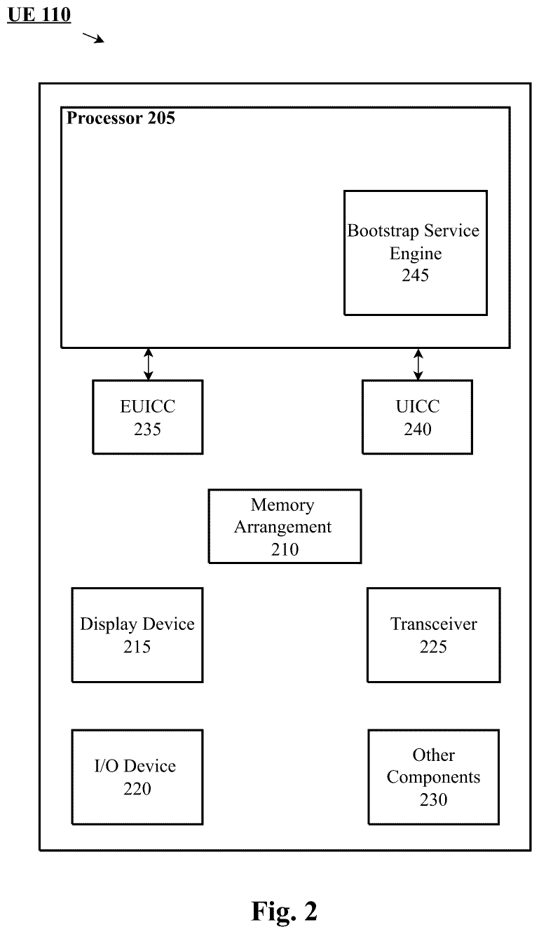

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225, other components 230, a eUICC 235 and UICC 240. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a bootstrap service engine 245. The bootstrap service engine 245 may perform a variety of operations for bootstrap services and other related techniques described herein. The operations may include, but are not limited to, enabling bootstrap services for user operations by selecting initial IMSI (i-IMSI) values from the pool of available, requesting temporary bootstrap profiles (b-IMSI), replacing the i-IMSI values with the temporary bootstrap profiles and utilizing the b-IMSI values for user operations.

The above referenced engine 245 being an application (e.g., a program) executed by the processor 205 is merely provided for illustrative purposes. The functionality associated with the engine 245 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

The eUICC 235 may be a hardware component embedded into the UE 110 configured to store a number of carrier profiles. The UICC 240 may be a small hardware component configured to be inserted into the UE 110 to enable the UE 110 to access services provided by the carrier.

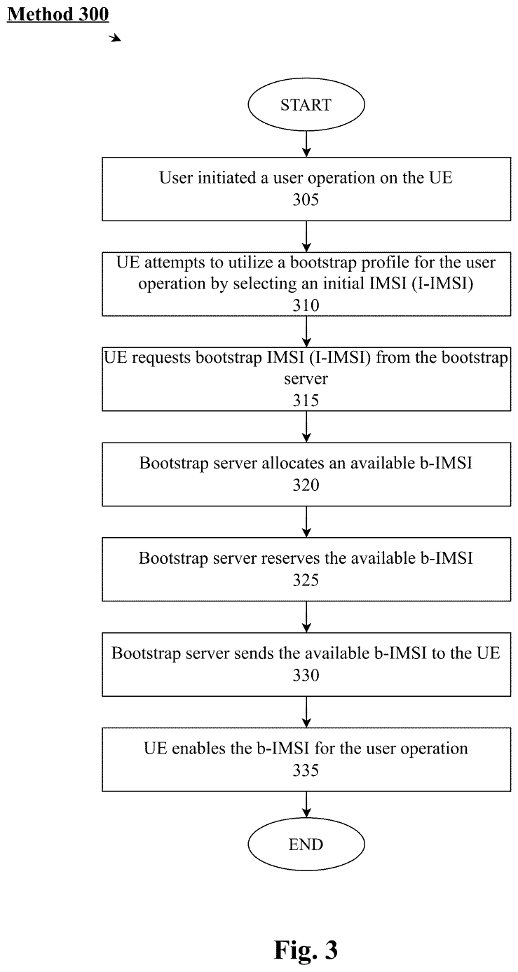

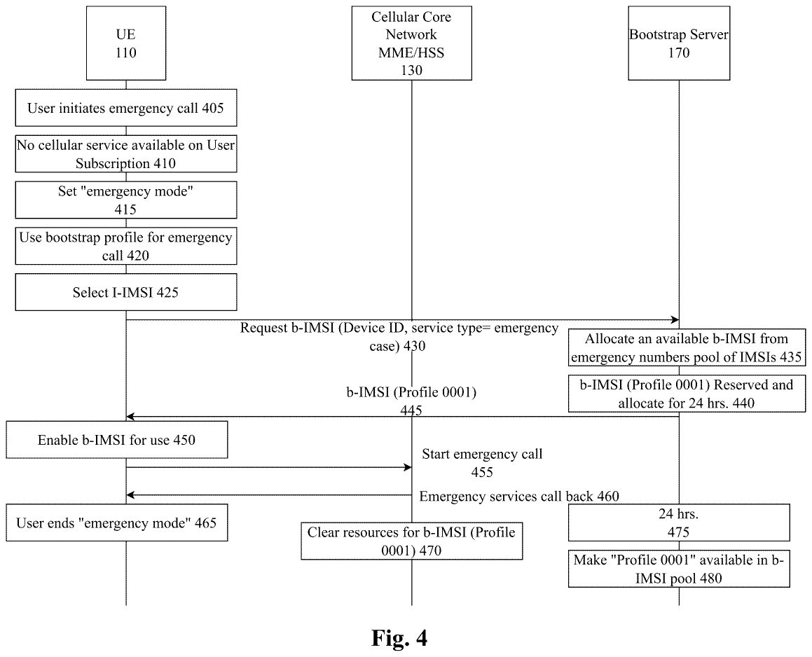

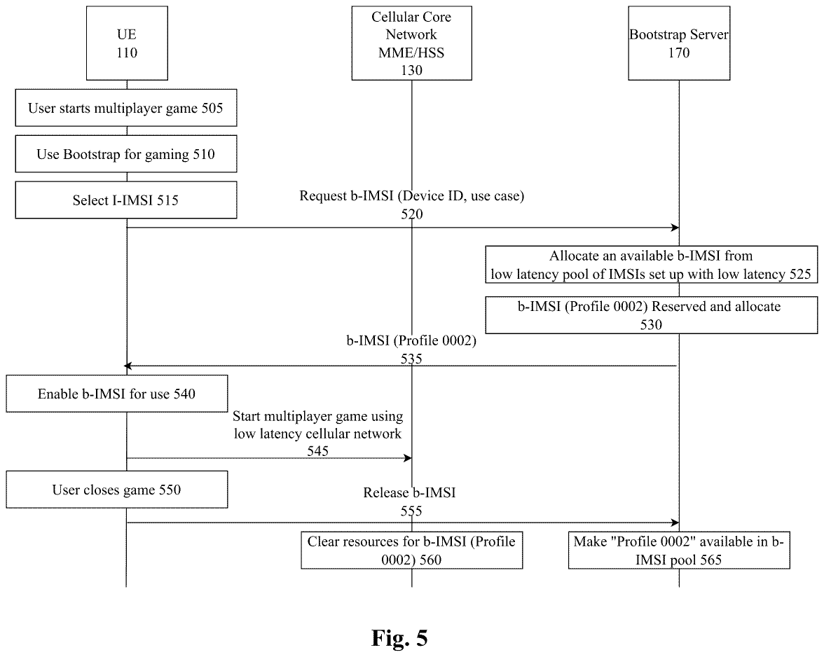

FIG. 3 shows an example method for obtaining and using bootstrap international mobile subscriber identity (b-IMSI) for specific user services according to various example embodiments. FIG. 3 will be described with regard to the network arrangement 100 of FIG. 1 and the UE 110 of FIG. 2. As will be described by way of example, the UE 110 may use the b-IMSI to facilitate specific cellular services that are not supported by the installed bootstrap profile available for use at the UE 110. The method 300 is a general method that may be implemented to obtain any type of b-IMSI from the bootstrap server. Specific use cases of an emergency call (call flow of FIG. 4) and multiplayer gaming (call flow of FIG. 5) are described below. However, as illustrated and described with reference to FIG. 3, the described use cases are only example and the method 300 may be used for any type of bootstrap profile.

In 305, a user initiates a specific user operation on the UE 110 (e.g., an emergency call in an area where the UE 110 has no voice service based on the user's subscription, a multiplayer gaming session that is not supported by the user's subscription, user attempts to download a new eSIM profile using a QR code while traveling internationally without data roaming enabled, etc.). However, as described by the examples, the user's subscription does not support the selected operation.

Accordingly, in 310, the UE 110 may attempt to use a bootstrap profile to perform the user operation. Specifically, the UE 110 may select an initial IMSI (i-IMSI) profile that is pre-installed on the UE 110 to allow the UE 110 connect to any available network. In this example, it may be considered that the i-IMSI profile also does not support the selected operation and therefore the UE 110 continues to fail to perform the selected user operation.

In 315, the UE 110 may request a bootstrap IMSI (b-IMSI) from the bootstrap server 170. The request sent by the UE 110 may include a service type. For example, if the selected operation is an emergency call, the UE 110 may include a service type of emergency in the request for the b-IMSI. In this way, the bootstrap server 170 will understand what type of b-IMSI to provide to the UE 110 so that the UE 110 may complete the selected user operation. Each b-IMSI profile may have one or more defined service types. The service type may be commonly defined between the UE 110 and the bootstrap server 170, for example, by definition in a standards document (e.g., 3GPP standards), by implementation agreement among carriers, UE manufacturers and third parties, etc.

In 320, the bootstrap server 170 may allocate an available b-IMSI from a pool of available bootstrap IMSIs for the specific user operation. As described above, the bootstrap server 170 may include a pool of bootstrap IMSI profiles. These b-IMSI profiles may include the one or more defined service types supported by the b-IMSI profile and the current status of the b-IMSI profile, e.g., available or currently allocated to another UE. Based on the information received in the request (e.g., the service type), the bootstrap server 170 will allocate one of the selected b-IMSI profiles to the UE 110.

There may be other factors that may be used by the bootstrap server 170 to allocate a b-IMSI profile to the UE 110 in addition to the requested service type. For example, the bootstrap server 170 may further select the particular b-IMSI based on, for example, the type of UE, the home PLMN of the UE, the subscription type of the UE, etc.

In 325, the bootstrap server 170 may reserve the available b-IMSI for the UE 110. The reservation of the b-IMSI may include marking or otherwise indicating that the selected b-IMSI is no longer available for use by other UEs and setting a condition for the b-IMSI to be returned to the pool after use by the UE 110. This condition may be, for example, the expiration of a timer, a conclusion of a session by the UE 110 using the b-IMSI, etc.

In 330, the bootstrap server 170 sends the selected b-IMSI to the UE 110. In 335, once the UE 110 receives the selected b-IMSI, the UE 110 may enable the b-IMSI and perform for the selected user operation.

As stated above, the UE 110 may utilize a temporary bootstrap profile for a specific user operation during limited cellular service at the UE 110. The following will provide example call flows for two example use cases where the user operation is an emergency call (FIG. 4) or starting a multiplayer game (FIG. 5). However, these user operations are only examples and that, there may also be other user operations that use the bootstrap IMSI (b-IMSI).

FIG. 4 illustrates an example user operation for initiating emergency call services according to various example embodiments. FIG. 4 will be described with regard to the network arrangement 100 of FIG. 1, the UE 110 of FIG. 2 and the method of FIG. 3. The example of FIG. 4 is shown as a signaling diagram between the UE 110, the cellular core network 130 and the bootstrap server 170. Specifically, the cellular core network 130 in this example is a Mobile Management Entity (MME) and Home Subscription Service (HSS) of a local network, e.g., a network with which the UE 110 may communicate.

In 405, the user initiates an emergency call service on the UE 110. However, as shown in 410, in this example, the UE 110 does not have service to perform the emergency call at the time the user initiates emergency call service. There may be many reasons why the UE 110 does not have service to perform the emergency call, e.g., the user's home network does not offer voice services in the user's current location. The particular reason for the UE 110 not having the service to perform the selected operation is not relevant to the example embodiments. The UE 110 may alert the user of the lack of cellular service available based on the user subscription to perform the emergency call. However, there is no requirement that the UE 110 inform the user.

In 415, the UE 110 may set the cellular service mode on the UE 110 to an emergency service mode. In 420, the UE 110 may then attempt to use a bootstrap profile for the emergency call. Thus, in 425, the UE 110 may select an initial IMSI (i-IMSI) that is pre-installed on the UE 110. However, in this example, the bootstrap profile that may be pre-installed on the UE 110 may only provide data services to the UE 110. The emergency call service may require voice services. For example, allocating every bootstrap profile with a phone number for voice services on every UE may not be ideal and cost effective. Thus, the UE 110 will not be able to complete the emergency call using the i-IMSI.

The example embodiments introduce a mechanism that allows the UE 110 to initiate an emergency call service even when its original subscription and the pre-installed i-IMSI do not support the emergency call services. As described above, this mechanism allows the UE 110 to retrieve another bootstrap profile that supports emergency call services.

Thus, in 430, the UE 110 sends a request for a b-IMSI to the bootstrap server 170 through an established connection between the UE 110 and the core cellular network 130. For example, as described above, the UE 110 may establish a data only connection to the local cellular network using the i-IMSI. The UE 110 may use this data only connection to communicate with the local cellular network to send the request for the b-IMSI to the bootstrap server 170. The request for the b-IMSI may include a unique device identification (ID) and a service type value indicating a reason for which the UE 110 is requesting an allocation of the b-IMSI value. Thus, in this example embodiment, the use case may indicate that the user intends to initiate an emergency call service on the UE 110, e.g., service type of emergency.

In 435, the bootstrap server 170 allocates a b-IMSI value from a pool of available b-IMSI values to the UE 110. In this example, the bootstrap server 170 determines an available b-IMSI value from the pool of b-IMSIs that support the service type emergency.

In 440, the selected b-IMSI value may be reserved and associated with the UE 110 (indicated as profile 0001 in FIG. 4). In the example embodiment, the bootstrap server 170 may be configured to reserve and allocate the b-IMSI value for a set time period (e.g., 24 hrs).

In 445, the bootstrap server 170 may return the selected b-IMSI value (associated with the bootstrap profile 0001) to the UE 110. The bootstrap server 170 may initialize an expiration timer associated with the b-ISMI value once the UE 110 receives the b-IMSI value.

In 450, the UE 110 may be configured to enable the bootstrap profile with the selected b-IMSI value and the associated profile parameters. After enabling the bootstrap profile with the selected b-IMSI value, the UE 110 may proceed to start the emergency call through an established connection between the UE 110 and the cellular core network 130 as shown in 455. That is, in the example embodiment, the UE 110 may establish a connection with the network using the credentials of the bootstrap profile configured with the b-IMSI value.

In 460, the core network may establish a connection that allows the UE 110 to receive a call back in emergency mode. For instance, in an emergency, a user may need to receive a call back after the user placed the emergency call. Thus, when the user uses the b-IMSI (profile 0001) value for the emergency call, the network may have access to a call back number associated with the b-IMSI value (profile 0001) that allows easy call back in the emergency mode.

In 465, the user may end the emergency mode on the UE 110. For example, the user may end the emergency call after the emergency call service is completed or after the user determines there is no need for the UE 110 to be in an emergency mode. Accordingly, in 470, the network may clear the resources allocated for the b-IMSI (profile 0001) value. However, as previously mentioned, the bootstrap server 170 may associate an expiration timer (e.g., 24 hrs) with the b-IMSI allocated to UE 110. Thus, when the timer associated with the b-IMSI (profile 0001) value expires, the bootstrap server 170 may send an indication to the network after the set time (in this case 24 hrs) is exhausted as shown in 475.

Accordingly, in 480, the bootstrap server 170 may return the b-IMSI (profile 0001) value to the pool of b-IMSI values available for allocation to UE 110.

Thus, the example embodiments allow the UE 110 to attach to other networks that are not registered as the preexisting subscription on the UE 110 to perform certain user operations. For example, a user may be subscribed with a network carrier (e.g., T-Mobile) may be roaming in an area with a different network coverage (e.g., AT&T, Verizon, etc.) and therefore the user's network subscription may fail to provide service to the user. Thus, the bootstrap service mechanism configured on the UE 110 may allow the user to obtain correct credentials for the user's operations regardless of the network subscription on the UE 110.

Thus, the example embodiments may allow the user to obtain network services at any location regardless of whether the UE 110 is connected to the subscribed network or not. Additionally, the user may be able to obtain parameters (for e.g., phone number) dynamically for certain user operations as needed by the user.

As previously mentioned, in other example embodiments, the user operation may be described with regards to the user starting a multiplayer game.

FIG. 5 illustrates an example user operation for initiating multiplayer gaming according to various example embodiments. FIG. 5 will be described with regard to the network arrangement 100 of FIG. 1, the UE 110 of FIG. 2 and the method of FIG. 3. The example of FIG. 5 is shown as a signaling diagram between the UE 110, the cellular core network 130 and the bootstrap server 170.

In 505, a user may initiate a multiplayer gaming service on the UE 110. The multiplayer gaming service may require a low latency network. For example, the user may require a latency close to the latency that may be obtained on a Wi-Fi connection. However, at the time the user starts the multiplayer gaming service (e.g., Fortnite), the UE 110 may be connected to a cellular network that may fail to consistently provide a quality of service (QoS) sufficient for the game.

5G NR networks may offer a defined QoS using a network feature such as network slicing. However, this feature may only apply to specific use cases within the network. For example, the UE 110 may be configured to dedicate part of the network slicing to specific use cases such as low latency, (e.g., close to Wi-Fi) for certain use cases such as gaming, virtual reality etc. A user playing a multiplayer game on the UE 110 subscribed to a specific cellular service may lack QoS associated with the service. Thus, when the user initiates the multiplayer game on the UE 110, the user may request a low latency bootstrap profile that has been pre-allocated and preactivated on the service to obtain dedicated low latency for the time period the user may engage in the game. Accordingly, in the example embodiment, a user may obtain and utilize a temporary bootstrap profile for the multiplayer gaming with dedicated low latency to engage in the game.

Returning to FIG. 5, in 510, when the user initiates a gaming service, the UE 110 may use bootstrap services for the multiplayer gaming because the user's subscription does not support the low latency connection required for the gaming services. In 515, the UE may select a pre-installed i-IMSI profile. However, in this example, it may be considered that the pre-installed i-IMSI profile may lack the low latency to engage in the multiplayer gaming service.

Accordingly, in 520, the UE 110 may send a request to the bootstrap server 170 through the established connection to request a temporary b-IMSI. The request for the b-IMSI may include a unique device ID and a service type value indicating a reason for which the UE 110 is requesting an allocation of the b-IMSI value. Thus, in this example embodiment, the use case may indicate that the user intends to engage in a multiplayer gaming session using the UE 110, e.g., service type of gaming.

In 525, the bootstrap server 170 allocates a b-IMSI value from a pool of available b-IMSI values to the UE 110. In this example, the bootstrap server 170 determines an available b-IMSI value from the pool of b-IMSIs that support the service type gaming.

In 530, the selected b-IMSI value may be associated with the UE 110 (indicated as profile 0002 in FIG. 5). Additionally, the bootstrap server 170 may be configured to reserve the b-IMSI value for the user operation at the UE 110. In the example embodiment, the bootstrap server 170 may be configured to reserve the b-IMSI value until a predetermined condition is satisfied, e.g., the user closes the gaming session.

In 535, the bootstrap server 170 may return the selected b-IMSI value (associated with the bootstrap profile 0002) to the UE 110. In 540, the UE 110 may be configured to enable the bootstrap profile with the selected b-IMSI value and the associated profile parameters. After enabling the bootstrap profile with the selected b-IMSI value, the UE 110 may proceed to start the multiplayer game using the low latency cellular network through an established connection between the UE 110 and the core cellular network 130 as shown in 545. That is, in the example embodiment, the UE 110 may establish a connection with the network using the credentials of the bootstrap profile configured with the b-IMSI value that the user may use to engage in the multiplayer game.

In 550, the user may end or close the game on the UE 110 after the user is done engaging in the game. Accordingly, in 555, the UE 110 may be configured to release the b-IMSI value after the user sends an indication that the game has ended or is closed.

Thus, in 555, cellular core network 130 may be configured to clear any resources for the b-IMSI (profile 0002) value associated with the bootstrap profile for the UE 110. Consequently, in 560, the bootstrap server 314 makes the b-IMSI (profile 0002) value available in the pool of b-IMSI values available for allocation to other UEs.

Thus, in this example embodiment, the user may be able to optimize the resources allocated to the UE 110. For instance, in some cases, the user may be provided with low latency from other network subscriptions based on the user's location at the time the user may request for the temporary bootstrap profiles.

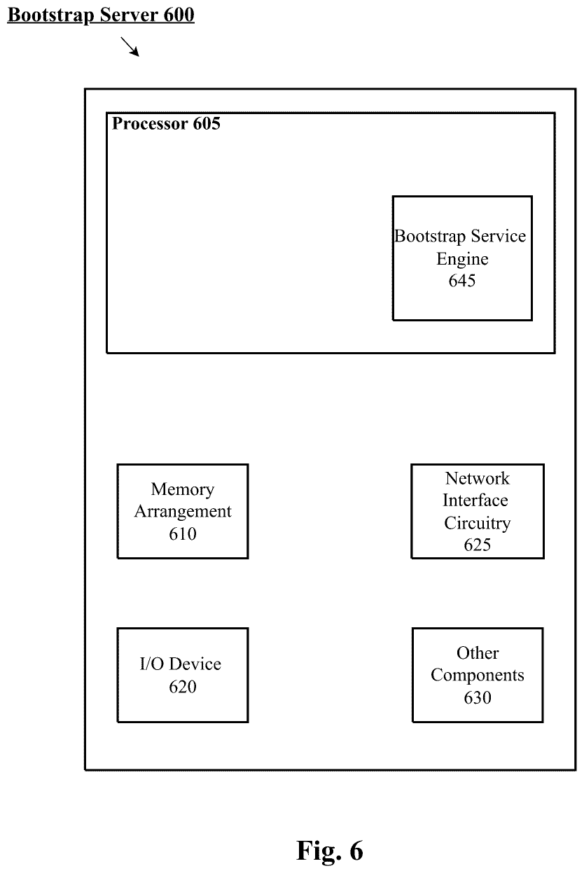

FIG. 6 shows an example bootstrap server 600 according to various example embodiments. The bootstrap server 600 will be described with regard to the network arrangement 100 of FIG. 1. The bootstrap server 600 may include a processor 605, a memory arrangement 610, an input/output (I/O) device 620, network interface circuitry 625, and other components 630. The other components 630 may include, for example, a power supply, a data acquisition device, ports to electrically connect the bootstrap server 600 to other electronic devices, etc.

The processor 605 may be configured to execute multiple engines of the bootstrap server 600. For example, the engines may include a bootstrap service engine 645. The bootstrap service engine 645 may perform a variety of operations for bootstrap services and other related techniques described herein. The operations may include, but are not limited to, the allocating one or more of temporary bootstrap profiles to the UE 110 to perform specific user operations.

The above referenced engine 645 being an application (e.g., a program) executed by the processor 605 is merely provided for illustrative purposes. The functionality associated with the engine 645 may also be represented as a separate incorporated component of the bootstrap server 600 or may be a modular component coupled to the bootstrap server 600, e.g., an integrated circuit with or without firmware. For example, the integrated circuit may include input circuitry to receive signals and processing circuitry to process the signals and other information. The engines may also be embodied as one application or separate applications. The example embodiments may be implemented in any of these or other configurations of a bootstrap server.

The memory arrangement 610 may be a hardware component configured to store data related to operations performed by the bootstrap server 600, e.g., the temporary bootstrap profiles.

The network interface circuitry 625 may be a hardware component configured to establish a connection with the cellular core network 130 and/or any other appropriate type of network. The network interface circuitry 625 includes circuitry configured to transmit and/or receive signals (e.g., control signals, data signals). Such signals may be encoded with information implementing any one of the methods described herein. The processor 605 may be operably coupled to the network interface circuitry 625 and configured to receive from and/or transmit signals to the network interface circuitry 625. The processor 605 may be configured to encode and/or decode signals for implementing any one of the methods described herein.

In the above examples, it was described that the operations or actions to be performed are user-initiated. However, in some examples, there may be system-initiated actions that may result in a bootstrap profile being used. For example, the system (e.g., the UE, the operating system (OS) of the UE, etc.) may determine that a software update is required. As a convenience to the end user, the download of the software update package may use a high throughput bootstrap profile that is zero-rated to the end user, e.g., no user data is consumed by this house-keeping operation occurring in the background.

In another example, where the system is an in-car telematics system, there may be a user eSIM for hotspot and/or other user facing features (live map updates, traffic data etc.). There may be background operations such as car data or software updates that may use a bootstrap profile for that purpose, but that operation would not be user initiated. Thus, the example embodiments are not limited to user initiated operations.

### EXAMPLES

In a first example, a method, comprising determining to initiate an operation, wherein the operation is related to a service type, determining that a current network connection does not support the operation, sending, to a bootstrap server, a request for a temporary bootstrap profile to perform the operation, wherein the request comprises an indication of the service type, receiving the temporary bootstrap profile from the bootstrap server and using the temporary bootstrap profile to perform the operation.

In a second example, the method of the first example, further comprising, prior to sending the request, attempting to perform the operation using a bootstrap profile that is preinstalled on a user equipment (UE).

In a third example, the method of the first example, wherein the temporary bootstrap profile comprises an international mobile subscriber identity (IMSI) value.

In a fourth example, the method of the first example, wherein the temporary bootstrap profile is assigned a profile identification.

In a fifth example, the method of the first example, wherein the request further comprises a unique identifier of a user equipment (UE).

In a sixth example, the method of the first example, wherein the temporary bootstrap profile is enabled for a user equipment (UE) until a predetermined condition is satisfied.

In a seventh example, the method of the sixth example, wherein the predetermined condition comprises an expiration of a time duration or a user termination of an application related to the operation.

In an eighth example, the method of the first example, wherein receiving the temporary bootstrap profile from the bootstrap server comprises storing the temporary bootstrap profile on an embedded Universal Integrated Circuit Card (eUICC) of a user equipment (UE).

In a ninth example, the method of the first example, further comprising sending, to the bootstrap server, a message indicating the UE is releasing the temporary bootstrap profile.

In a tenth example, the method of the first example, wherein releasing the temporary bootstrap profile comprises deleting the temporary bootstrap profile from an embedded Universal Integrated Circuit Card (eUICC) of a user equipment (UE).

In an eleventh example, the method of the first example, wherein the operation is associated with an emergency call service and the service type relates to the emergency call service.

In a twelfth example, the method of the first example, wherein the operation is associated with a multiplayer gaming service and the service type relates to the multiplayer gaming service.

In a thirteenth example, a processor configured to perform any of the methods of the first through twelfth examples.

In a fourteenth example, a user equipment (UE) comprising transceiver circuitry configured to communicate with a network and a processor communicatively coupled to the transceiver circuitry and configured to perform any of the methods of the first through twelfth examples.

In a fifteenth example, a method comprising receiving, from a user equipment (UE), a request for a temporary bootstrap profile, wherein the request comprises an indication of a service type, selecting the temporary bootstrap profile from a pool of temporary bootstrap profiles based on at least the service type, allocating the temporary bootstrap profile to the UE, wherein the temporary bootstrap profile is unavailable for use by other UEs when the temporary bootstrap profile is allocated to the UE and sending the temporary bootstrap profile to the UE.

In a sixteenth example, the method of the fifteenth example, wherein the temporary bootstrap profile comprises an international mobile subscriber identity (IMSI) value.

In a seventeenth example, the method of the fifteenth example, further comprising assigning a profile identification to the temporary bootstrap profile.

In an eighteenth example, the method of the fifteenth example, wherein the request further comprises a unique identifier of the UE.

In a nineteenth example, the method of the fifteenth example, further comprising enabling the temporary bootstrap profile for the UE until a predetermined condition is satisfied.

In a twentieth example, the method of the nineteenth example, wherein the predetermined condition comprises an expiration of a time duration or a user termination of an application related to the operation.

In a twenty first example, the method of the fifteenth example, further comprising receiving, from the UE, a message indicating the UE is releasing the temporary bootstrap profile.

In a twenty second example, the method of the twenty first example, further comprising deallocating the temporary bootstrap profile from the UE, wherein the deallocating makes the temporary bootstrap profile available in the pool of temporary bootstrap profiles.

In a twenty third example, the method of the fifteenth example, wherein the service type relates to an emergency call service.

In a twenty fourth example, the method of the fifteenth example, wherein the service type relates to a multiplayer gaming service.

In a twenty fifth example, a processor configured to perform any of the methods of the fifteenth through twenty fourth examples.

In a twenty sixth example, a bootstrap server comprising network interface circuitry configured to communicate with a user equipment (UE) and a processor communicatively coupled to the network interface circuitry and configured to perform any of the fifteenth through twenty fourth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
determine an operation is to be performed, wherein the operation is related to a service type;
determine that a current network connection does not support the operation;
generate, for transmission to a bootstrap server, a request for a temporary bootstrap profile to perform the operation, wherein the request comprises an indication of the service type;
process the temporary bootstrap profile; and
use the temporary bootstrap profile to perform the operation.

2. The apparatus of claim 1, wherein the processing circuitry is further configured to:
prior to generating the request, attempt to perform the operation using a bootstrap profile that is preinstalled on the apparatus.

3. The apparatus of claim 1, wherein the temporary bootstrap profile comprises an international mobile subscriber identity (IMSI) value.

4. The apparatus of claim 1, wherein the temporary bootstrap profile is assigned a profile identification.

5. The apparatus of claim 1, wherein the request further comprises a unique identifier of the apparatus.

6. The apparatus of claim 1, wherein the temporary bootstrap profile is enabled for the apparatus until a predetermined condition is satisfied, wherein the predetermined condition comprises an expiration of a time duration or a user termination of an application related to the operation.

7. The apparatus of claim 1, wherein the apparatus further comprises an embedded Universal Integrated Circuit Card (eUICC), wherein the temporary bootstrap profile is stored in the eUICC.

8. The apparatus of claim 1, wherein the processing circuitry is further configured to:
generate, for transmission to the bootstrap server, a message indicating the apparatus is releasing the temporary bootstrap profile, wherein releasing the temporary bootstrap profile comprises deleting the temporary bootstrap profile from an embedded Universal Integrated Circuit Card (eUICC).

9. The apparatus of claim 1, wherein the operation is associated with an emergency call service and the service type relates to the emergency call service.

10. The apparatus of claim 1, wherein the operation is associated with a multiplayer gaming service and the service type relates to the multiplayer gaming service.

11. The apparatus of claim 1, wherein the processing circuitry determines an operation is to be performed based on user input or a system initiated input.

12. An apparatus comprising processing circuitry configured to:
process, based on signals received from a user equipment (UE), a request for a temporary bootstrap profile, wherein the request comprises an indication of a service type;
select the temporary bootstrap profile from a pool of temporary bootstrap profiles based on at least the service type;
allocate the temporary bootstrap profile to the UE, wherein the temporary bootstrap profile is unavailable for use by other UEs when the temporary bootstrap profile is allocated to the UE; and
generate, for transmission to the UE, a message comprising the temporary bootstrap profile.

13. The apparatus of claim 12, wherein the temporary bootstrap profile comprises an international mobile subscriber identity (IMSI) value.

14. The apparatus of claim 12, wherein the processing circuitry is further configured to:
assign a profile identification to the temporary bootstrap profile.

15. The apparatus of claim 12, wherein the request further comprises a unique identifier of the UE.

16. The apparatus of claim 12, wherein the processing circuitry is further configured to:
enable the temporary bootstrap profile for the UE until a predetermined condition is satisfied.

17. The apparatus of claim 16, wherein the predetermined condition comprises an expiration of a time duration or a user termination of an application related to the operation.

18. The apparatus of claim 12, wherein the processing circuitry is further configured to:
process, based on signals received from the UE, a message indicating the UE is releasing the temporary bootstrap profile.

19. The apparatus of claim 18, wherein the processing circuitry is further configured to:
deallocate the temporary bootstrap profile from the UE, wherein the deallocating makes the temporary bootstrap profile available in the pool of temporary bootstrap profiles.

20. The apparatus of claim 11, wherein the service type relates to an emergency call service or a multiplayer gaming service.
